(19) United States
(12) Patent Application Publication
(10) Pub. No.: US 2026/0325951 A1
(43) Pub. Date: Oct. 22, 2026

(54) INTERACTIVE BOARD GAME WITH A DIGITAL GAME FLOW DYNAMIC

(71) Applicants: Tyrone Randolph, Palm Bay, FL (US); Victor Lavell Jordan, Upper Marlboro, MD (US); Shaun Adante' Randolph, Palm Bay, FL (US)

(72) Inventors: Tyrone Randolph, Palm Bay, FL (US); Victor Lavell Jordan, Upper Marlboro, MD (US); Shaun Adante' Randolph, Palm Bay, FL (US)

(21) Appl. No.: 19/416,251

(22) Filed: Dec. 11, 2025

Related U.S. Application Data
(60) Provisional application No. 63/735,222, filed on Dec. 17, 2024.

(51) Int. Cl. A63F 3/00; A63F 13/2145; A63F 13/52; A63F 13/537

(52) U.S. Cl. CPC A63F 3/001; A63F 3/00176; A63F 13/2145; A63F 13/52; A63F 13/537; A63F 2003/0011; A63F 2003/00186; A63F 2003/00996

(57) ABSTRACT

This disclosure introduces an interactive game aimed at promoting biblical knowledge through engaging gameplay. The game features a cross-shaped board with seven blank spaces that players fill using a variety of biblical questions and answers sourced from a dedicated database. Players interact through a digital interface displaying multiple card options, such as wild cards and Q&A cards, which influence the game's strategy. A 12-sided dice is used to determine card selections based on rolled icons. The game also includes a scoring system and vibrant interactive elements like LED lights and sound effects to enhance player experience.

### RELATED APPLICATIONS

This application claims priority to U.S. Provisional Patent Application Ser. No. 63/735,222 filed Dec. 17, 2024, now pending.

### FIELD OF THE INVENTION

This invention relates generally to an interactive board game with a digital game flow dynamic and more particularly to an interactive board game for players to fill blank spaces on a cross-board and which in its preferred embodiment, features a plurality of pre-determined action components associated with game play patterns to complete the blank spaces and wherein completion of the blank spaces represents a full cross.

### BACKGROUND OF THE INVENTION

The present invention relates to interactive gaming systems that integrate biblical knowledge with dynamic gameplay to promote learning, retention, and engagement. In particular, the invention discloses an interactive board game wherein players use a cross-1 board and pre-determined action components in conjunction with a digital die and a companion computer system to drive gameplay. This combination provides an educational experience that blends religious content with multi-modal interaction, including physical, visual, and digital feedback.

Conventional methods for teaching biblical concepts often rely on passive forms such as reading scripture, listening to lectures, or watching presentations. Such approaches can result in limited participant engagement and reduced retention of knowledge. Traditional tabletop games addressing biblical themes may focus on trivia but frequently lack an integrated mechanism that synchronizes physical components with digital game state.

The inventive interactive game introduces a cohesive digital-physical flow in which players progress by filling seven spaces on an individualized cross-board. Progress is driven by the interaction of pre-determined action components, including a set of pre-determined action components that govern progression, penalties, and turn order. A programmable die, mapped to the pre-determined action components, guides transfer from a companion container to players' placemats or the cross-board, thereby creating a hybrid experience that combines religious content with strategic decision-making and collaborative gaming dynamics.

To this end, a method for playing an interactive board game is disclosed. The method comprises a cross-shaped game board configured for individualized play, pre-determined action components stored in a companion container, a placemat for each player, and a digital 12-sided die. The cross-board is wired or wirelessly connected to a companion computer system that informs players of changes in the number and type of pre-determined action components and enables a programmable die roll mechanism whose outcomes correspond to the pre-determined action components. The method is further characterized by the following novel features: (1) digitally generating, by the companion computer system, a roll outcome for the 12-sided die; (2) transferring the corresponding pre-determined action component from the companion container to the player's mat or cross-board in accordance with the die outcome; and (3) terminating the game when a player completes a full cross by filling seven spaces on the cross-board, thereby declaring that player the winner.

### SUMMARY

This disclosure describes an interactive game designed to explore biblical knowledge through a strategic cross-board experience. Players aim to occupy a cross-shaped board consisting of seven blank spaces by selecting and placing pre-determined action components drawn from a physical card retainer with card types including conditional progression elements and specialized wild cards. A digital 12-sided die determines which card icons are drawn from a companion retainer and transferred to each player's placemat or cross-board. The drawn cards guide subsequent actions and game progression. A companion computer system facilitates the gameplay and includes a central software database of biblical questions and answers.

It is an additional advantage of the present invention to provide an interactive board game including a penalty avoidance component, a direct transit component, and a turn order override component as the specialized wild cards;

It is an additional advantage of the present invention to provide an interactive board game providing each player with a place mat for placement of the pre-determined action components for gameplay on a cross-shaped board having at least seven blank spaces arranged to form a cross and configured to be covered by the pre-determined action components associated with a game effect;

It is an additional advantage of the present invention to provide an interactive board game having a companion retainer for holding the pre-determined action components therein and wherein the companion retainer including icons representing each of the pre-determined action components;

It is still an additional advantage of the present invention to provide an interactive board game wherein the companion retainer is a one-way telecommunication device communicating with and being wirelessly connected to a companion computer system for informing the players to variations in the number of the pre-determined action components;

It is still an additional advantage of the present invention to provide an interactive board game wherein the companion computer system is equipped with a processor, a memory device coupled to the processor, and one or more custom-programmed software and databases for the random selection of the pre-determined action components by a virtual turn of a 12-sided die; and

It is still an additional advantage of the present invention to provide an interactive board game wherein each side of the die displays an icon representing each of the pre-determined action components.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

Additional advantages and features of the present invention will become more apparent when considered in light of the following specification and drawings.

### BRIEF DESCRIPTION OF THE DRAWINGS

The present embodiments are illustrated by way of the figures of the accompanying drawings, which may not necessarily be to scale, in which like references indicate similar elements, and in which:

FIG. 1 is an exemplary graphical user interface showing the start screen in accordance with the companion computer system provided herein;

FIG. 2 shows the login screen and user profile workflow for the interactive board game;

FIG. 3 is a plan view illustrating the game components for the interactive board game provided herein;

FIG. 4 is an exemplary graphical user interface showing the 12-sided die in accordance with the companion computer system provided herein;

FIG. 5 is a schematic representation of a cross-board configuration showing the cross-board playing surface with seven spaces for the pre-determined action components;

FIG. 6 is a schematic representation of a cross-board configuration with the pre-determined action components distributed on the seven spaces thereof and forming a full cross;

FIG. 7 illustrates a four-panel layout of a placemat showing three pre-determined action components to proceed with a game play in accordance with the interactive board game provided herein;

FIG. 8 shows the meter screen on the user interface with a vertical rectangular progress bar indicating the strength of the die roll;

FIG. 9 provides a descriptive illustration of the 12-sided die used in the interactive board game provided herein showing each icon labeled with its corresponding action component;

FIG. 10 shows the companion container housing the four pre-determined action components arranged for selection to transfer to players during gameplay;

FIG. 11 shows images of cards that depict matching corresponding die icon images;

FIG. 12 illustrates an exemplary biblical question and answer after selecting the conditional progression element icon from the die roll;

FIG. 13 is a flowchart of a gameplay when a conditional progression element is selected, showing the sequence from rolling the die to resolving a correct or incorrect answer in accordance with an embodiment of the interactive board game provided herein;

FIG. 14 is a flow diagram of the networked interactive board game architecture, showing players and the companion retainer connecting via the internet to a companion computer system and cloud server hosting modules for user interface, account/profile, game modules, meter and die roll components;

FIG. 15 is a flow diagram of the networked interactive board game architecture, showing the wireless connectivity of the companion computer system and the companion retainer; and

FIG. 16 is system architecture of the interactive board game provided herein showing the communication of data exchange between the computer system and the companion container.

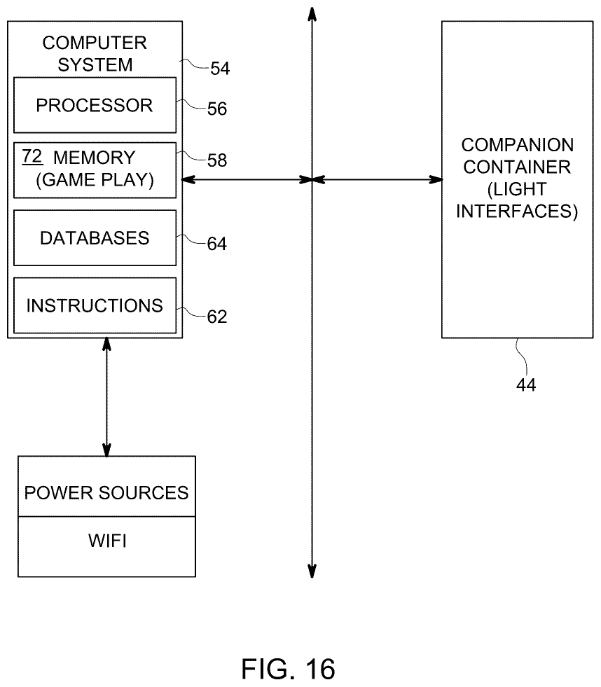

### DETAILED DESCRIPTION

The following detailed description is a contemplated mode of carrying out an interactive board game 10 with a digital game flow dynamic as described herein. Although the interactive board game 10 with a digital game flow dynamic is explained in relation to an illustrated embodiment, it is understood that many possible modifications and variations can be made without departing from the spirit and scope of the disclosure.

### Definitions

As used herein, the term cross-board refers to the cross-shaped playing surface for a given player. The player places pre-determined action components 12 to form a contiguous cross pattern. The cross-board 34 comprises seven blank spaces 36 arranged to form a cross 40 and may be embodied as a physical board, a projected ambient surface, or a hybrid electronic/physical representation that supports the placement of the components 12 and provides the visual feedback of a full cross.

As used herein, the term pre-determined action components 12 refer to a set of discrete game elements (e.g., playing cards or card-like tokens) that are prepared in advance of gameplay and are randomly drawn by players based on game rules or electronic die outcomes.

As used herein, the term penalty avoidance component refers to a type of pre-determined action component 12 that, when applied or activated, provides a mechanism to avoid or mitigate a penalty resulting from an incorrect answer, missed action, or other in-game misstep, consistent with the rules stored in the companion software.

As used herein, the term direct transit component 26 refers to a type of pre-determined action component 12 that, when rolled or activated, permits a player to advance along the cross-board 34 path independent of standard turn order, subject to the rules of the game as implemented by the companion software.

As used herein, the term turn order override component 28 refers to a type of pre-determined action component 12 that, when drawn, rolled, or otherwise activated, allows a player to alter the normal turn sequence, such as by gaining an extra turn or otherwise shifting the order of play, in accordance with the game rules implemented by the companion software.

As used herein, the term companion retainer refers to a storage and display assembly that houses the pre-determined action components 12 and presents corresponding icons 46 on its exterior. The companion container is communicatively linked to the cross-board 34 and to the companion software, and is used to transfer pre-determined action components 12 to a player's personal mat or cross-board 34 in response to game events (e.g., a die roll).

As used herein, the term placemat refers to a personal, player-specific mat or surface onto which pre-determined action components 12 can be placed or transferred from the companion container during gameplay. The placemat 32 may visually reflect the current state of a player's available or held components and may interface with the cross-board's 34 signaling or wireless system to coordinate game actions.

As used herein, the term conditional progression element 14 refers to a card that presents a question (e.g., biblical in content within the preferred embodiment) and an associated correct answer in a database in which success of the answer enables conditional advancement on the cross-board 34 or transfer of the card's progression element to the player's cross-board 34. The conditional progression element 14 is one type of pre-determined action component 12 and is subject to the game's answer-evaluation rules as stored in the companion software.

As used herein, the term 12-sided die (d12) 66 refers to a digital die 66 used by the companion software to generate outcomes corresponding to the pre-determined action components 12. Each face of the die 66 bears an icon 46 associated with a particular pre-determined action component 12. The die outcome governs which component 12 is transferred or activated within the game.

As used herein, the term companion software refers to the software module or application running on the companion computer system 54 that (i) stores a database of pre-determined action components 12, (ii) maps die outcomes to component 12 transfers and game effects, (iii) manages game state, (iv) provides the user interface 76 visuals, and (v) facilitates communication with the cross-board 34 and with the companion container 44.

As used herein, the term digital roll refers to a virtual or electronic execution of a die-roll operation by the companion computer system 54. The digital roll randomly selects an outcome from the set of twelve possible outcomes on the 12-sided die 66, and the selected outcome dictates the corresponding pre-determined action component 12 to be transferred or activated.

As used herein, the term winner 42 refers to the event or condition in which a player has completed the required objective of the game, such as filling all seven spaces 36 on the cross-board 34 with the appropriate pre-determined action component 12 according to the defined game rules, thereby terminating gameplay in favor of that player.

Therefore, the interactive board game 10 as provided herein is designed for diverse environments, making it an invaluable tool for individuals and groups seeking to enhance their biblical knowledge while enjoying an engaging experience. This innovative game can be played in various settings, including family gatherings, church events, educational programs, and community outreach activities, where fostering collaboration and learning is essential. The game accommodates a wide range of players, from children to adults, and appeals to both casual gamers and those with a deep interest in biblical teachings. Its dynamic gameplay mechanics, featuring strategic card selections and interactive elements, ensure that players remain engaged and motivated to learn, making it an ideal choice for educational institutions and religious organizations looking to enrich their programs.

The inventor envisions a versatile and engaging design for the interactive board game 10 that allows for customization and adaptability to various themes and player preferences. Each pre-determined action component 12 of the game can be stylized with unique names to enhance the experience; for instance, the specialized wild cards 22 may be referred to as a “Grace card,” the Rescue card as a “Forgiven card,” and the non-playable card as a “Block card.” The board, aptly named the “Cross Bord,” and the cardholder, termed the “Kard Bord,” reflect a cohesive thematic approach.

Beyond biblical questions, the game can incorporate a wide array of topics, such as historical facts, scientific concepts, language vocabulary, or ethical dilemmas, making it suitable for different educational contexts and audience interests. The shape of the board can be altered to add visual variety, and the game can be produced to accommodate varying numbers of players, from small groups to larger gatherings. Additionally, the color schemes can be customized to suit different occasions or preferences, and the styles of music accompanying the game can be adapted to create an immersive atmosphere. The order of play for the cards can also be modified, allowing for different gameplay dynamics, ensuring that the game remains fresh and engaging for repeat players. This adaptability makes the interactive board game 10 an ideal tool for learning and entertainment across multiple settings.

### Probability Distribution

Wherein the die 66 can be configured to generate a specific outcome with a pre-determined probability (of at least 75% of landing on an icon 46 corresponding to a conditional progression element 14 that, when landed upon, allows the player to add said conditional progression element 14 to the cross-board 34 if the correct answer is achieved for the biblical question provided thereon. The die 66 having a probability of at least 8.3% of landing on an icon 46 corresponding to a penalty avoidance component 24 whereby landing on the icon 46 provides forgiveness for a wrong answer by the player and the player places the penalty avoidance component 24 on the player's mat. The die having a probability of at least 8.3% of landing on an icon 46 corresponding to a direct transit component 26 whereby landing on the icon 46 allows the player to move forward on the cross-board 34 path if the direct transit component 26 is received as a die roll and the die 66 having a probability of at least 8.3% of landing on an icon 46 corresponding to a turn order override component 28.

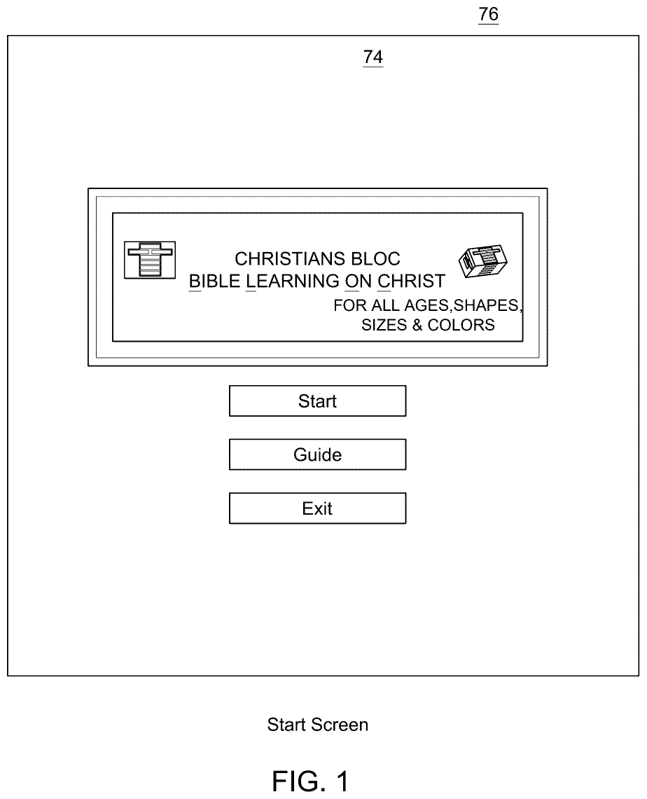

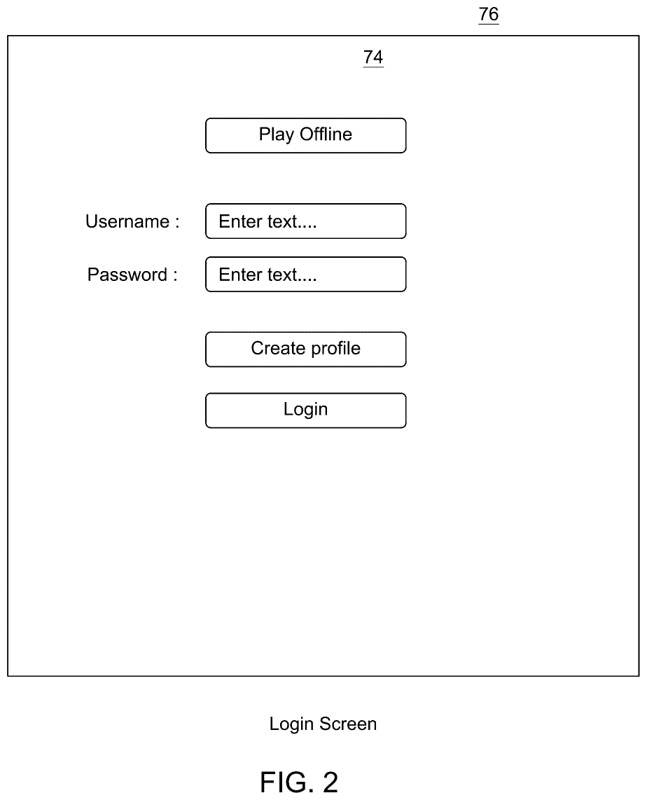

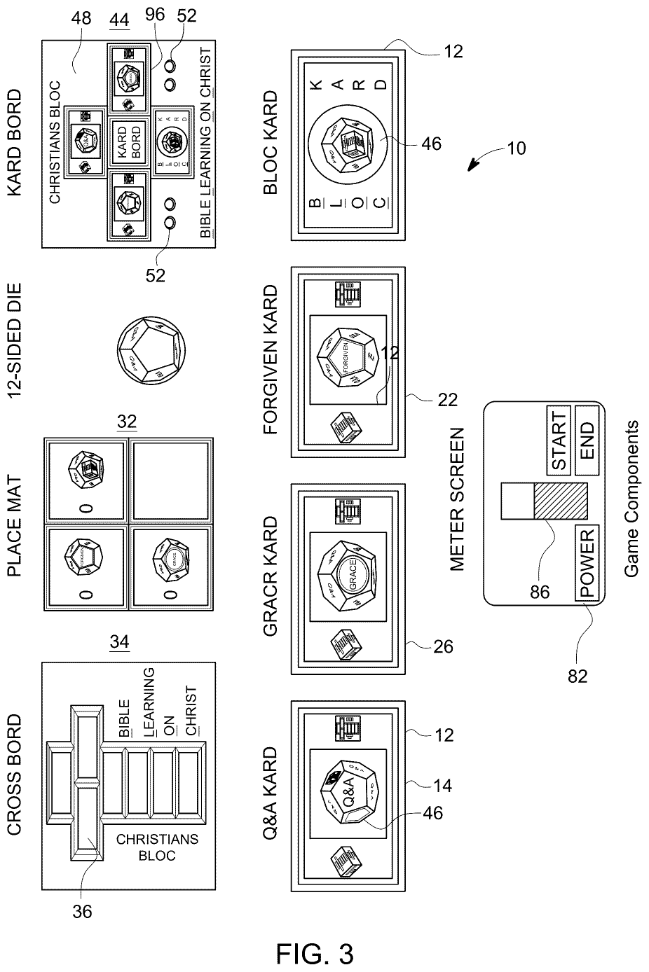

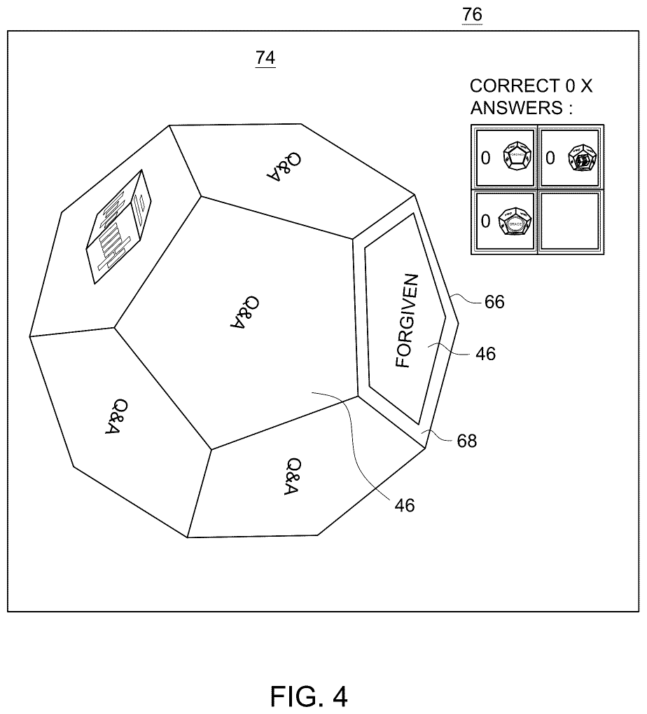

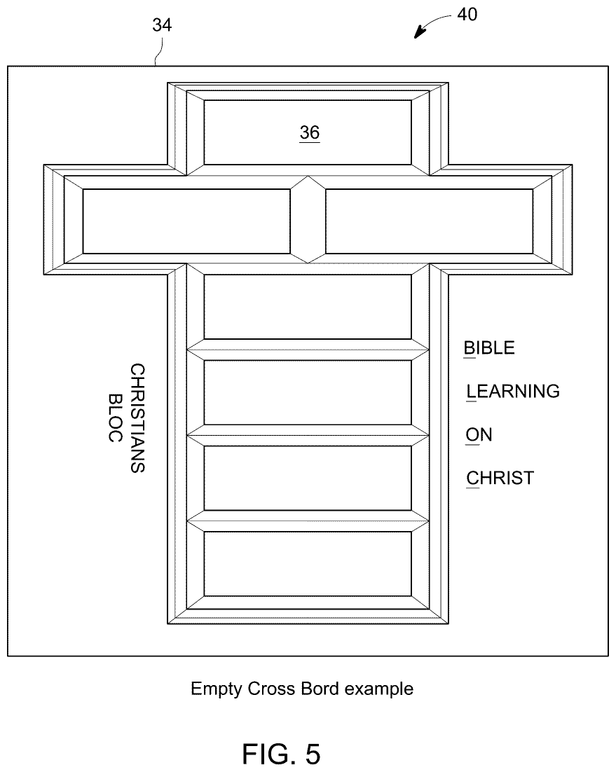

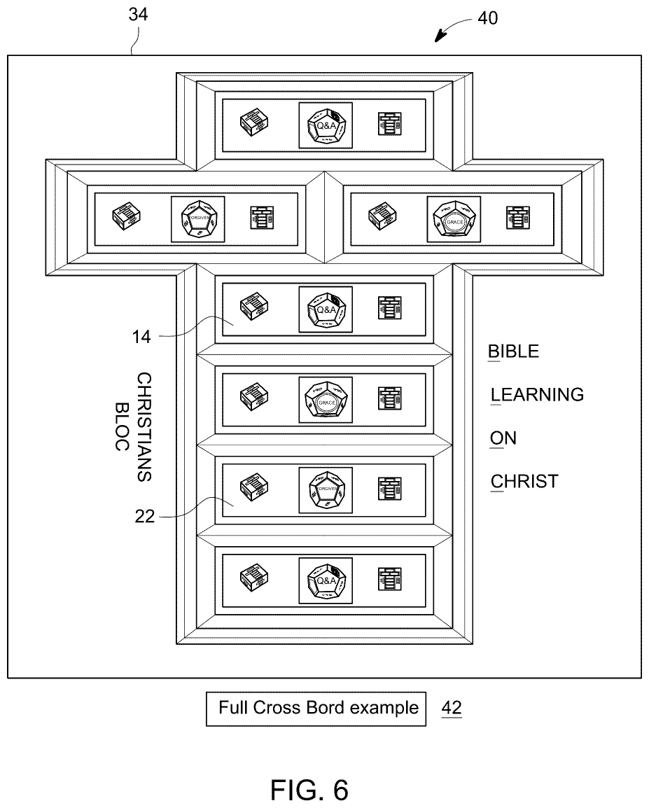

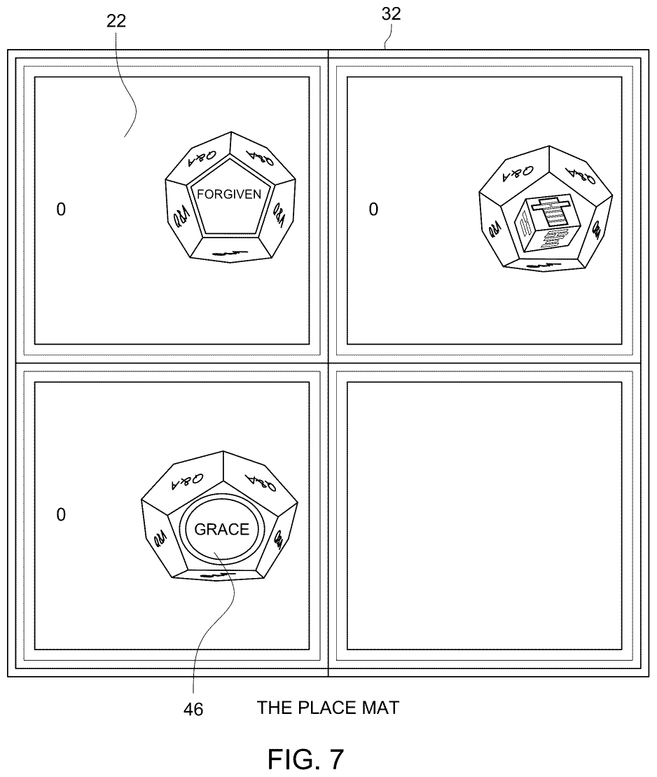

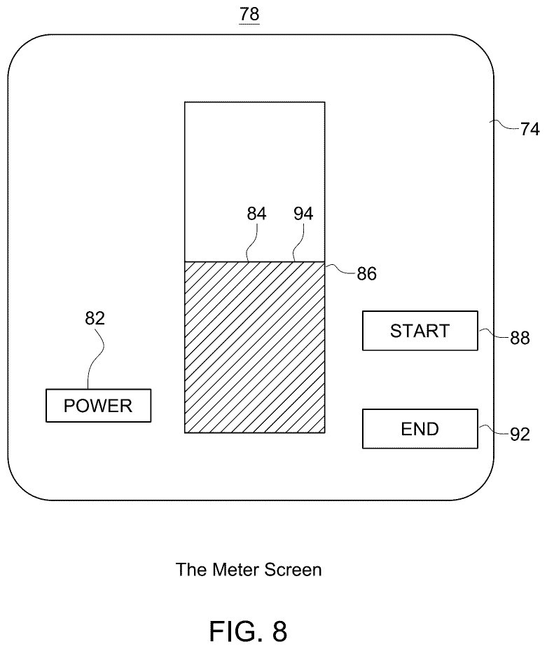

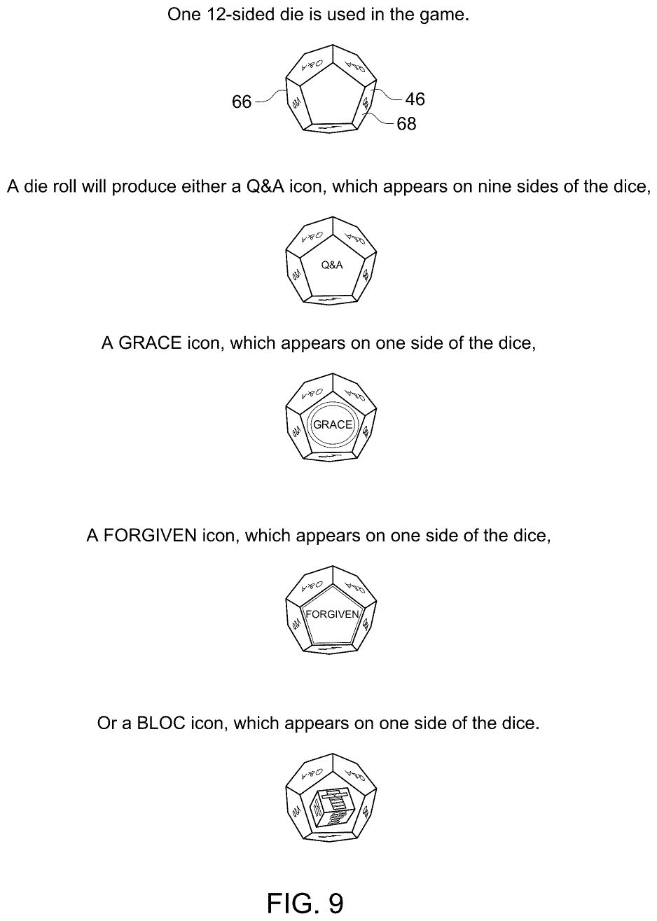

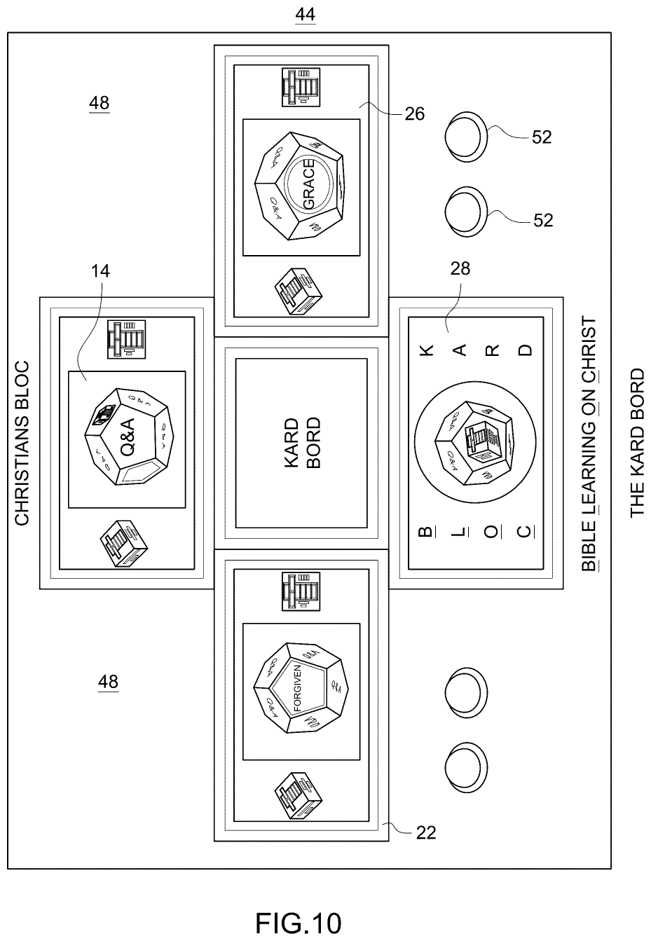

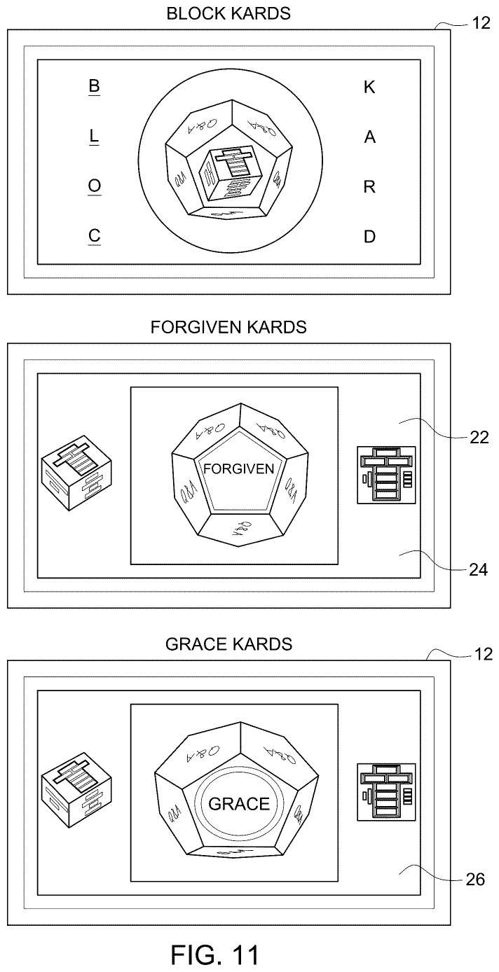

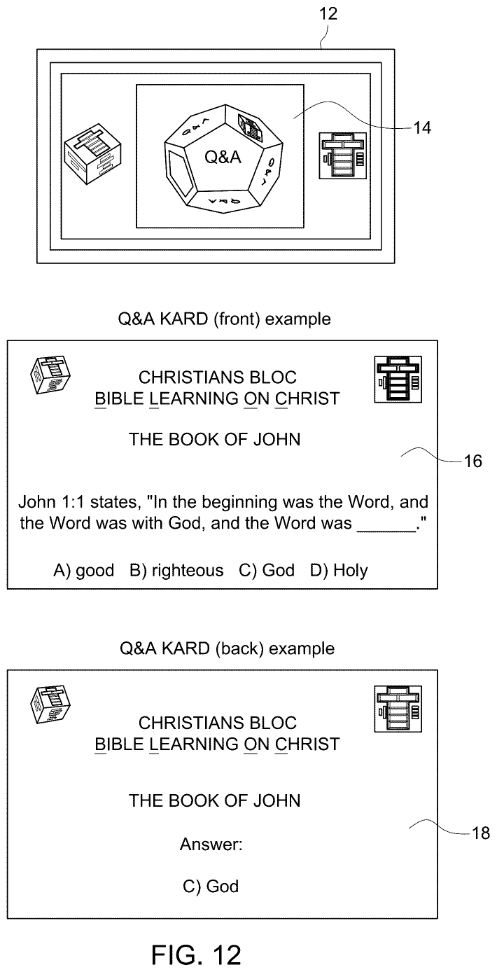

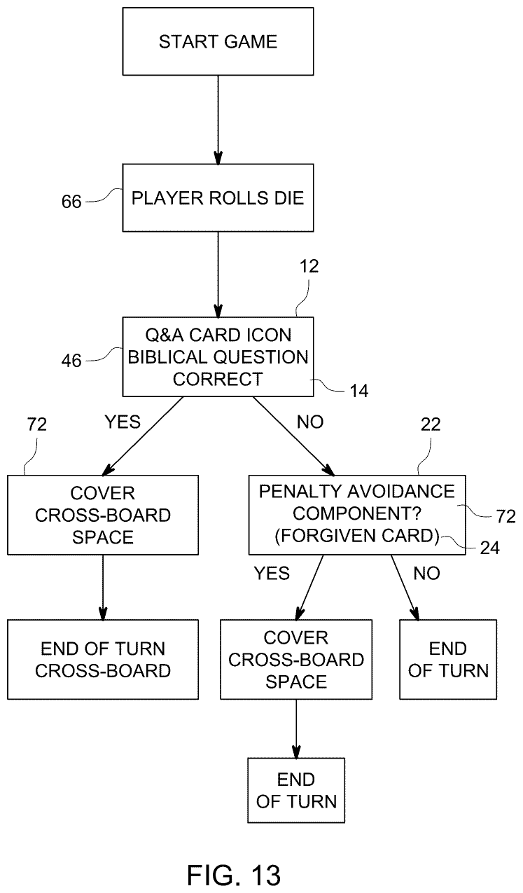

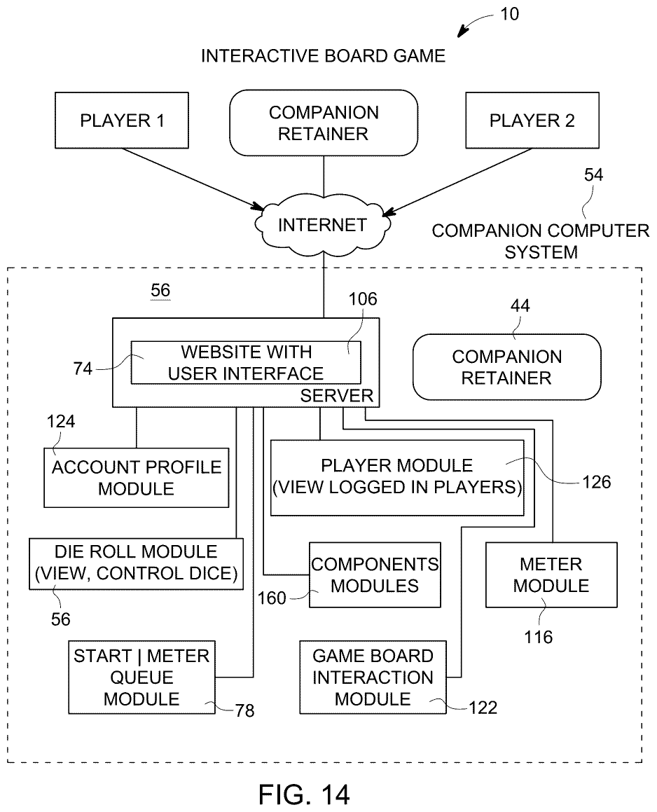

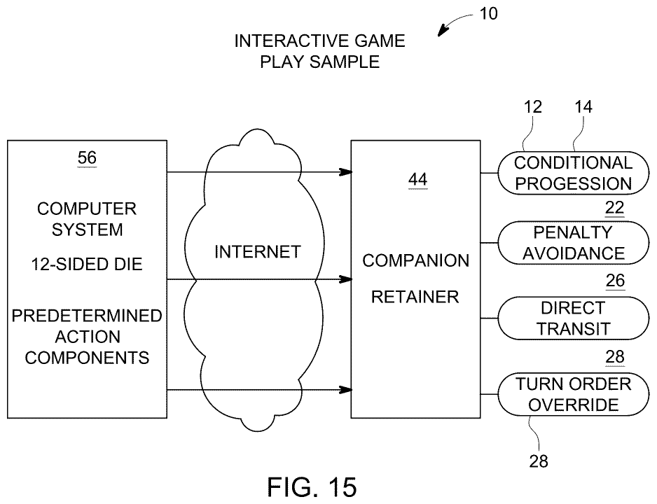

For example, and without limitation, FIGS. 1-15 show the modified method of playing an interactive board game 10 according to one embodiment of the present disclosure wherein the objective of the interactive board game 10 is for players to fill seven blank spaces 36 on an individualize cross-board 34 with any combination of a plurality of biblical questions and answers based on the pre-determined action components 12 and game play patterns, and wherein the completion of the seven blank spaces 36 represents a full cross 40.

The modified method of playing the interactive board game 10 comprising a conditional progression card 14 and specialized wild cards 22 as the pre-determined action components 12 of the interactive board game 10. The conditional progression card 14 incorporates at least one biblical question 16 and its associated answer 18. A penalty avoidance component 24, a direct transit component 26, and a turn order override component 28 are included as the specialized wild cards 22.

Each player receives a placemat 32 for placement of the pre-determined action components 12 after the player receives a predetermined action component 12 from a roll outcome of a die 66, and as a game strategy the player transfers the component 12 to an individualized cross-board 34 having at least seven blank spaces 36 arranged to form a cross 40 and configured to be covered by the pre-determined action components 12 associated with the additional die outcomes.

A companion retainer 44 for holding the pre-determined action components 12 therein and wherein the companion retainer 44 includes icons 46 representing each of the pre-determined action components 12. The companion retainer 44 is programmed as a one-way telecommunication device with a top surface 48 and at least one depressable color signal 52 is disposed on the top surface 48 thereof and the companion retainer 44 communicates with and is wirelessly connected to a companion computer system 54 for informing the players to variations in the number of the pre-determined action components 12.

The companion computer system 54 is equipped with a processor 54, a memory device 58 coupled to the processor 54 and the memory device 58 storing instructions 62 adapted to be executed by the processor 54. One or more custom-programmed software and databases 64 is provided for the random selection of the pre-determined action components 12 by a virtual turn of the 12-sided die 66 wherein each side 68 of the die 66 displaying an icon 46 representing each of the pre-determined action components 12.

The custom-programmed software and database store the pre-determined action components 12 based on the icon 46 represented on the die 66, storing game play patterns 72 and utilize a series of math functions to produce the chance sequence of the pre-determined action components 12 required for each roll of the die 66. A display screen 74 having a user interface 76 provides a meter screen 78 for displaying the power indicator 82 comprising an expandable line and a strength of the roll indicator 86 for the die 66. The meter screen 78 further comprising a first touch interface to start 88 and a second touch interface 92 to end die roll and wherein the meter screen 78 further displays the speed of the die roll based on the final length of the expandable line 94.

The companion computer system 54 is further enabled to provide a digital die roll mechanism and wherein the die roll mechanism is programmed to produce at least one randomly selected icon 46 once the meter screen 78 is pressed. A roll of the die 66 randomly generates a roll outcome by displaying the icon 46 on the dice representing the pre-determined card and wherein a player transfers the corresponding pre-determined action component 12 from the companion retainer 44 to the player's placemat 32 for strategic placement on the individualized cross-board 34 of the player.

The number and type of pre-determined action components 12 correspond to a pre-determined game effect and outcome probabilities of the die 66, such that the ratio of each pre-determined action component 12 within the companion retainer 44 is consistent with a probability distribution of the die 66.

Each digital roll of the die 66 randomly selects the pre-determined card to generate outcomes determined by the icon 46 on the die representing the pre-determined card and a player transfers the corresponding pre-determined action component 12 from the companion component to the player's placemat 32. The user interface 76 visually represents the icon 46 for the transferred corresponding pre-determined action component 96 on the player's placemat 32 for game-play actions based on the outcome of the die rolls.

The light circuitry provides light signals to the companion retainer 44 when the icon 46 appears as a roll outcome on the die 66, with LED indicators activated to convey the results. The companion computer system 54 signals the companion retainer 44, which then emits a light signal in response to any change in the number of specialized cards 22 present.

The method for utilizing the specialized wild card 22 in the interactive board game 10 further involves drawing a specialized wild card 22 from the companion retainer 44 to fill a blank space 36 on the player's cross-board 34 when a specialized wild card 22 icon is rolled on the die 66. The wild card selection does not require answering a biblical question, and placement of the wild card allows the player to roll the die again.

The method for utilizing the direct transit component 26 includes receiving an icon for the grace card and transferring it to a player's cross-board 34 when the grace card icon is rolled, enabling the player to use the direct transit component 26 for a free turn, regardless of whether a conditional progression element was answered correctly or incorrectly; this may permit multiple non-playable cards to be used successively within the same turn if the player holds more than one non-playable card on the placemat 32.

The selection of a penalty avoidance component 24 by a player as a roll outcome awards the player forgiveness after an incorrect answer to a biblical question, this forgiveness card serves to mitigate penalties. The turn order override component 28 transfers at least one turn order override element from the companion container to the cross-board 34 upon being rolled on the die 66. In this scenario, the player may also utilize a thereby allowing the player to roll the die 66 again. A player is declared a winner 42 by being the first player to complete the cross pattern 40 by filling the seven spaces 36 on the individualized cross-board 34.

### Companion Retainer

The companion retainer 44 houses the pre-determined action components 12 before each die roll and before play begins. Upon setup, the retainer 44 loads a complete, physically accessible set of cards and, in a digital-augmented embodiment, synchronizes with the companion computer system 54 to establish the initial distribution and order. Players may view icons 46 on the top surface 48 thereof or via the connected user interface 76 display to confirm which cards are available. This design ensures a clear labeling of pred-determined element types to facilitate quick selection and transfer during gameplay. The arrangement supports efficient pre-roll checks and enables rapid deployment of pre-determine elements into the transfer workflow when a roll occurs.

### Placemat

After a die roll outcome, the placemat 32 temporarily stores the drawn pre-determined action component until the player places it on their cross-board 34 or uses it to enact a game effect. The placement area on the placemat 32 is sized to accommodate the pre-determined action components 12 with visual icons 46 featured on each placemat 32 to keep the components 12 individually secured during the game. Each placemat 32 can ensure an orderly transfer sequence of each pre-determined action component 12. This reduces misplacement and enables each player to plan subsequent placements on their cross-board 34 in response to the next die roll.

### Roll Outcomes

Each roll outcome can trigger one or more transfers from the companion retainer 44 to the player's placemat 32 and to their individualized cross-board 34. The mechanism may be automatic or user-initiated, depending on the game mode, and is coordinated by the companion computer system 54. Transferred cards appear in clearly labeled slots on the placemat 32 and then in designated cross-board 34 positions, enabling strategic placement and immediate visibility of available actions for the next turn. This transfer system supports synchronous play across players and maintains the die-driven pacing of the game.

### Direct Transit Component (Grace Card)

The direct transit component 26 provides a capability to advance on the cross-board 34 independent of standard turn order when its icon appears on the die 66. The system recognizes the component as a special action that grants a free or accelerated move, potentially bypassing conventional sequencing. The effect of the direct transit component 26 can be constrained by additional rules (e.g., one use per roll or per turn) to preserve balance, and the companion software can be adjusted to enforce these constraints while optionally allowing a chain of eligible actions if the sample player receives more than one direct transit component 26 in a game.

### Biblical Questions and Answers

The companion retainer 44 is used primarily to hold the pre-determined action components 12 during gameplay. Similarly, the companion software can include a dedicated module that stores a database of biblical questions 16 and answers 18 aligned with the aforementioned conditional progression card 14. The module can be configured to support the search, retrieval, categorization (e.g., difficulty, topic), and versioning to track question sets used in games. Additional configurations can provide for interfaces to select questions during Q&A card encounters, evaluating user-provided answers, and triggering progression or penalties based on correctness.

### Cloud Connectivity Module

The companion software can be configured to provide a module for updating biblical questions, saving game state, and enabling cloud connectivity. The updated companion software can retrieve new or revised questions, game rules, or the same for improving gameplay. A save feature can be included to preserve progress locally or in the cloud, thereby supporting a resumption of play on multiple devices. Cloud connectivity enables cross-device synchronization, back-up, and optional social or remote gameplay features, while maintaining data integrity and security through standard encryption and authentication mechanisms.

### Color Signals During Gameplay

The depressable color signals 52 on the interactive cross-board 34 are raised and protruding outwardly to provide tactile and visual feedback. The design ensures distinct colors correspond to different action components 12 or states (e.g., available, transferred, activated). The tactile prominence aids accessibility, enabling players to identify and depress the correct areas without ambiguity. The circuitry or haptic subsystem synchronizes color changes with software events (card transfers, roll outcomes, or mode transitions) to convey real-time status to players and any on-board lighting schemes.

In an embodiment, when a pre-determined action component 12 such as a conditional progression element 14 is rolled on the die 66, animated transitions such as flips, fades, or lifts can reveal the associated content (questions, answers, or instructions) and can be synchronized with audible feedback to reinforce the changes in the game. These digital interactions can be driven by the roll of the die 66 wherein rolling a conditional progression element 14 icon can visually lift it from a companion retainer 44 that can be provided on-screen and onto the cross-board 34. The revealed content can be prominently displayed and may subsequently fade out. This can be accompanied by synchronized sounds to indicate progression in the game. The software can thereby maintain digital mappings between the die icons, pre-determined action components 12, their content, and their associated game effects 42 (e.g., penalties or turn-order changes). Therefore, the penalty avoidance components 24, direct transit components 26, and turn order override component 28 can be provided with animated transitions in accordance with the disclosure provided herein.

### General Know Questions

Beyond biblical content, the system supports generic knowledge questions as an additional or alternative progression element. The database and question-selection logic branch to present non-biblical questions with corresponding answers 18, allowing variety in difficulty and category. Player responses are evaluated by the companion software, and outcomes influence game progression, card eligibility, or penalties, with results displayed via the user interface 76 and reflected on the cross-board 34 and placemats 32.

### Multi-Cross-Board Synchronization

The interactive board game 10 is designed to accommodate multiple individualized cross-boards 34 that can be synchronized with the companion computer system 54. Each cross-board 34 can be designed to maintain its own seven-space layout 36, card transfers, and player state while remaining synchronized to a central controller. The synchronization enables cooperative or competitive play across players, with the companion software handling conflict resolution, timing alignment, and unified display of game state, ensuring a consistent experience regardless of the number of individualized cross-boards 34 in play.

### LED Lights and Sound Options

The system provides a plurality of LED lighting and sound effects to enhance engagement during gameplay. LEDs illuminate in response to events such as card transfers, die rolls, question outcomes, or activation of special components. The audio suite can be configured to include selectable soundscapes, alerts, and spoken prompts to guide players through the turn sequence and indicate state changes. The lighting and sound modules are configurable, allowing players to tailor intensity, tempo, and effect mappings to suit preferences and accessibility needs.

### Audio Output and Vibration Coordination

In addition to LED lighting, the interactive board game 10 provided herein can be configured support audio output and vibration feedback coordinated with the companion computer system 54. Vibration patterns reflect actions such as successful transfers, incorrect answers, or the activation of special cards. The audio cues would complement the visual cues and thereby deliver a multi-sensory experience while keeping sound levels appropriate for different environments.

### Wi-Fi Connectivity

The interactive board game 10 can include Wi-Fi connectivity to enable cloud updates, remote gameplay, and data synchronization across devices. The device can use secure wireless communication (e.g., WPA2/WPA3) to connect to a network, authenticate users, and exchange game data, and content updates. The Wi-Fi module can be updated to support firmware updates and optional online play modes, ensuring the system remains current and capable of expanding content over time.

### Bluetooth Connectivity

The interactive board game 10 provided herein can be configured to include Bluetooth connectivity for pairing with mobile devices, wearables, or other peripherals. Bluetooth connectivity would enable transfer of the game state, card transfers, or control signals between the board and companion apps. It supports standard pairing procedures, secure enclaves for user data, and compatibility with multiple device profiles to maximize interoperability in various setups and use cases.

### Power Source

The interactive board game 10 can be powered by a rechargeable power source (battery or integrated power pack). The design can emphasize energy efficiency, with sleep modes to extend battery life during extended gameplay. The charging interface, battery level indication, and smart power management can enable convenient recharging between sessions and ensure consistent performance for LEDs, sound, sensors, and wireless communication.

### Console Game

A console embodiment of the interactive board game 10, as described in the claims, could be developed as a self-contained digital platform. In this approach, the console would render an individualized cross-board 34 with at least seven spaces 36 for each player, a virtual placemat per player, and a full set of pre-determined action components 12 represented as on-screen cards. A digital 12-sided die 66 would drive gameplay, with each face corresponding to a specific action component and the corresponding transfers to the player's placemat 32 or cross-board 34 proceeding under clearly defined rules. The companion software would manage card storage in a virtual retainer, card selection from a dynamic on-screen pool, and the conditional progression card 14, including Q&A questions associated with biblical questions 16 optionally generic knowledge prompts. The system would provide audiovisual feedback through graphics, audio cues and LED lighting effects to indicate roll outcomes, transfers of pre-determined action components 12, and changes to the game. The user interface 76 would include a virtual cross-board, a placemat 32 area showing held and placed cards, a card-selection screen with icons 46 and descriptions, a die area with engaging animations, and a meter or status display for power, roll, and game flow controls such as start, pause, and end. Controls could utilize a gamepad, keyboard/mouse, or a companion mobile app for card navigation, die rolling, and placement actions on the cross-board and placemats 32. The console architecture would comprise modular components: a Card Retainer that holds the full card set pre-roll, a cross-board Manager that tracks seven-space layouts 36 and applies card effects, a Placemat Manager for held and played cards, a Die Engine for random outcomes aligned with the card distribution, a Progression Engine for Q&A and potential progression events, coordinated visuals, audio, and optional vibration. Data models would include card metadata (type, icon, effect, constraints), per-player game state (board occupancy, placemat contents, held cards), die-face mappings, and a rules engine to enforce turn order, grace and bloc card effects, and win conditions.

### Board Game

In another embodiment, the interactive board game 10 as provided herein can be realized entirely as a physical board game that preserves the core elements and interactions recited in the claims. In this embodiment, the game can include tangible individualized cross-board 34 for at least one player. Each board being provided with seven or more blank spaces 36 arranged to form a cross 40. Each player is equipped with a placemat to hold and organize the pre-determined action components 12 drawn from a card retainer, which serves as the physical storage and dispensing unit for the full deck of specialized cards 22 such as Q&A cards, Grace cards, Forgiven cards, Bloc cards, and other specialized wild card components. The roll of a single 12-sided die 66 determines which action component 12 is activated or transferred and the corresponding game effect is transferred on the player's cross-board 34 and placemat 32. Overall, the board game configuration without the digital gameplay experience would include the claimed mechanisms and objectives, including the interaction between die outcomes, card transfers, cross-board 34 placement, and the eventual completion of a cross-pattern 40 to determine the winner 42.

### Game Show Format

In still another embodiment, a game show format could feature a central processor that manages overall game flow and audience interaction, a broadcast display that showcases gameplay, rules, and instructions to the audience, and on-stage contestant interaction with a cross-board and live card selection. The system coordinates die-like outcomes, card transfers, and placements on the cross-board, while audience participation is integrated through real-time updates, voting or input prompts, and synchronized visual and audio cues to drive pace and engagement.

### Mobile Application

In still another embodiment, a digital platform implements the interactive board game 10 as a secure online experience that requires user login. Each player creates or uses an account with unique credentials to start the game. The login process provides role-based access (player, host, and administrator) and supports two-factor authentication for added security. Upon successful authentication, the system loads the player's saved game state, including their cross-board, placemat contents, and the current card retainer status, ensuring continuity across play sessions and devices. The login mechanism also enables personalized settings for user interface preferences, accessibility options, and notification preferences for audience or co-players in a shared-room format.

The interactive game comprises a processor and memory coupled to store and execute the software instructions. One or more custom-programmed software modules and databases store a plurality of biblical questions 16 and answers 18, linked to the pre-determined card selection options and corresponding gameplay patterns 72. A display screen 74 provides the user interface with gameplay instructions and presents the virtual card retainer showing available card options, including at least a wild card, a Q&A card, a rescue card, and a block card. The architecture supports both single-player and multi-player modes, with per-player cross-boards containing at least seven blank spaces 36 arranged in the shape of a cross 40, and placemats 32 that hold the cards selected during the game. A single 12-sided die (d12) is represented in the software with icons 46 corresponding to the card options, and a meter screen 78 displays a power indicator 82 with an expandable line and controls to start or end the die roll, while conveying the speed of the die roll through the line's final length.

Gameplay revolves around a random selection of cards based on the die roll, where the icon 46 shown on the die dictates which card is drawn from the card retainer. The scoring system and user interface update in real time to reflect transfers from the retainer to a player's placemat or directly to the cross-board, with subsequent interactions enabling players to place cards for progress toward completing a cross pattern 40 and triggering game effects. The interface provides visual and audio cues synchronized with card transfers, die outcomes, and allows players to interact with the transferred cards to perform subsequent game actions as rules permit. The host, audience, or automated rules engine can provide prompts and read-aloud guidance to enhance engagement and accessibility.

The game architecture supports a family of card types, including wild cards, Q&A cards, rescue cards, and block cards, each with specific effects tied to progression and turn order. Wild cards can fill cross-board blanks and may permit re-rolling, while rescue cards provide a means to recover from incorrect answers and can be re-assigned to the cross-board after use. Non-playable cards are drawn and placed on the placemat, offering free turns or other special actions; such cards are returned to the card board after use per game rules. Correct and incorrect

A number of illustrative embodiments have been described. Nevertheless, it will be understood that various modifications may be made without departing from the spirit and scope of the various embodiments presented herein. Accordingly, other embodiments are within the scope of the following claims.

What is claimed is:

1. A modified method of playing an interactive board game using pre-determined action components, the modified method of playing an interactive board game comprising,
including a conditional progression card and specialized wild cards as the pre-determined action components of the interactive board game;
the conditional progression card having at least one biblical question and answer provided thereon;
including a penalty avoidance component, a direct transit component, and a turn order override component as the specialized wild cards;
providing each player with a place mat for a strategic hold of the pre-determined action components for placement on a cross-board having at least seven blank spaces arranged to form a cross and configured to be covered by the pre-determined action components associated with a game effect;
providing a companion retainer for holding the pre-determined action components therein and wherein the companion retainer including icons representing each of the pre-determined action components;
programming the companion retainer as a one-way telecommunication device with a top surface and at least one depressable color signal being disposed on the top surface thereof and the companion retainer communicating with and being wirelessly connected to a companion computer system for informing the players to variations in the number of the pre-determined action components;
equipping the companion computer system with a processor, a memory device coupled to the processor and the memory device storing instructions adapted to be executed by the processor; providing one or more custom-programmed software and databases for the random selection of the pre-determined action components by a virtual turn of a 12-sided die wherein each side of the die displaying an icon representing each of the pre-determined action components;
storing by the custom-programmed software and databases, the pre-determined action components based on the icon represented on the die and game play patterns and wherein the custom-programmed software and databases utilize a series of math functions to produce the chance sequence of the pre-determined action components required for each roll of the die;
providing a display screen having a user interface and a meter screen displaying a power indicator comprising an expandable line and a roll strength indicator for the die; the meter screen further comprising a first touch interface to start and a second touch interface to end the roll of the die and wherein the meter screen further displays the speed of the die roll based on the final length of the expandable line;
enabling the companion computer system to provide a digital die roll mechanism of the die and wherein the die roll mechanism being programmed to produce at least one randomly selected icon once the meter screen is pressed; and wherein a roll of the die randomly generates a roll outcome by displaying the icon on the dice representing the pre-determined card and wherein a player transfers the corresponding pre-determined action component from the companion retainer to the player's placemat for strategic placement on the player's cross-board;
matching the number and type of pre-determined action components to a pre-determined game effect and outcome probabilities of the die, such that the ratio of each pre-determined action component within the companion storage component is consistent with a probability distribution of the die;
randomly selecting by each digital roll of the die the pre-determined action component to generate outcomes determined by the icon on the die representing the pre-determined action component and wherein a player transfers the corresponding pre-determined action component from the companion component to the player's placemat;
the user interface visually representing the icon representing the transferred corresponding pre-determined action component on the player's placemat for game-play actions based on the outcome of the digital die roll;
light circuitry for producing the light signals to the companion retainer when the icon for a pre-determined action component is shown as a roll outcome on the die;
signaling by the companion computer system to the companion retainer, the companion retainer generating a light signal in response to a change in the number of pre-determined action components;
including a method for utilizing a specialized wild in the interactive board game, comprising: drawing a specialized wild card from the cross-board to fill a blank space on the player's cross board when a specialized wild card icon is rolled on the die and wherein the selection of the specialized wild card does not require a correct answer to a biblical question and wherein selection of the specialized wild card thereof allows the player to roll the die again after placing the specialized wild card on the cross-board;
including a method for utilizing the direct transit component in the game, comprising receiving an icon for the direct transit component and transferring it to a player's place mat when direct transit component icon is rolled, allowing the player to use the direct transit component for a free turn;
Including a method of providing a player with a penalty avoidance component card once the player provides an incorrect answer to a biblical question;
Including a method for utilizing the turn order override component comprising allowing at least one turn order override component from the companion container to cross-board once used the turn order override component is rolled on the die and thereby enabling the player to roll the die again; and
Including a method of playing the interactive board game whereby filling the seven spaces on the cross-board completes a full cross pattern, thereby declaring a winner.

2. The interactive board game of claim 1 wherein the companion retainer of the interactive game stores the pre-determined action component before each die roll.

3. The interactive board game of claim 1 wherein the place mat of the interactive game temporarily stores the pre-determined action components after the outcome of each die roll.

4. The interactive board game of claim 1 wherein a roll outcome determines one or more card transfer actions from the companion retainer to the player's place mat and cross-board.

5. The interactive board game of claim 1 wherein the direct transit component of the interactive game allows a player to advance regardless of standard turn order once the direct transit component icon is rolled on the die.

6. The interactive board game of claim 1 wherein the player may advance once regardless of standard turn order once the direct transit component is received.

7. The interactive board game of claim 1 wherein the companion software of the interactive board game contains a software module containing a database of a plurality of biblical questions and answers associated with the conditional progression elements.

8. The interactive board game of claim 1 wherein the companion software of the interactive board game contains a software module for updating the biblical questions, saving the game, and cloud connectivity.

9. The interactive board game of claim 1 wherein the depressable color signals of the interactive board game are raised and protruding outwardly therefrom.

10. The interactive board game of claim 1 wherein the interactive board game can have pre-determined action components including generic knowledge questions.

11. The interactive board game of claim 1 wherein the interactive board game is adapted for a plurality of LED lights and sound options to engage during the plurality of game-play actions.

12. The interactive board game of claim 1 wherein the interactive board can have audio output capabilities and vibration capabilities coordinated with the companion computer system.

13. The interactive board game of claim 1 wherein the interactive board game has Wi-Fi connectivity.

14. The interactive board game of claim 1 wherein the interactive board game has Bluetooth connectivity.

15. The interactive board game of claim 1 wherein the interactive board game has a chargeable power source.

16. The interactive board game of claim 1 wherein the interactive game is implemented as a website further comprising a digital interface for player interaction and card selection and a virtual display screen showing the plurality of pre-determined card selection options, game-play instructions, the cross-board with at least seven blank spaces arranged in the shape of a cross for at least one player, a place mat for at least one player, the single 12-sided dice, meter screen, and the plurality of LED lights and sound options that are engaged during the plurality of game-play actions.

17. The interactive game of claim 1 wherein the interactive game is implemented as a console game further comprising a digital interface for player interaction and card selection and a virtual display screen showing the plurality of pre-determined card selection options, game-play instructions, the cross-board with at least seven blank spaces arranged in the shape of a cross for at least one player, a place mat for at least one player, the single 12-sided dice, meter screen, and the plurality of LED lights and sound options that are engaged during the plurality of game-play actions.

18. The interactive game of claim 1 wherein the interactive game is implemented as a physical game board system, further comprising game-play instructions, a tangible cross board with at least seven blank spaces arranged in the shape of a cross for at least one player, a place mat for at least one player, the card retainer, and the single 12-sided dice.

19. The interactive game of claim 1 wherein the interactive game is implemented as a game show format, further comprising a central processor for managing game flow and audience interaction, a broadcast display for showcasing gameplay and instructions to an audience, contestant interaction with the cross-shaped board and card selection during the show.
